(19) United States
(12) Patent Application Publication
(10) Pub. No.: US 2019/0264488 A1
(43) Pub. Date: Aug. 29, 2019

(54) FOREIGN MATTER DETECTION SENSOR

(71) Applicant: Aisin Seiki Kabushiki Kaisha, Kariya-shi (JP)

(72) Inventors: Wataru Hattori, Okazaki-shi (JP); Tatsuya Nishio, Toyota-shi (JP)

(73) Assignee: AISIN SEIKI KABUSHIKI KAISHA, Kariya-shi (JP)

(21) Appl. No.: 16/272,001

(22) Filed: Feb. 11, 2019

(30) Foreign Application Priority Data
Feb. 23, 2018 (JP) 2018-030973

(51) Int. Cl. E05F 15/44; G01V 3/02

(52) U.S. Cl. CPC E05F 15/44; B60J 5/101; G01V 3/02

(57) ABSTRACT

A foreign matter detection sensor detecting nipping of a foreign matter between a peripheral edge of an opening part and an opening and closing body, includes: an outer coat having an insulation property and elasticity in an elongated hollow shape; a plurality of electrode wires separately arranged from each other in the outer coat; and a terminal part provided at an end of the outer coat in a longitudinal direction, and configured to cover connection parts of lead wires connected to the plurality of electrode wires and draw lead wires out from a bottom surface part to an outside. The terminal part includes, in a periphery of the bottom surface part, a plurality of guide parts guiding arrangement directions of lead wires from the bottom surface part to different directions.

### CROSS REFERENCE TO RELATED APPLICATIONS

This application is based on and claims priority under 35 U.S.C. § 119 to Japanese Patent Application 2018-030973, filed on Feb. 23, 2018, the entire content of which is incorporated herein by reference.

### TECHNICAL FIELD

This disclosure generally relates to a foreign matter detection sensor configured to detect nipping of a foreign matter between a peripheral edge of an opening part and an opening and closing body.

### BACKGROUND DISCUSSION

Hitherto, as this type of a foreign matter detection sensor, there has been proposed a foreign matter detection sensor including a sensor unit, power supply members, and a sealing member (terminal part) (see, for example, JP2014-154324A: Reference 1). The sensor unit includes a hollow insulation body in an elongated and hollow shape with elasticity and an insulation property, and two electrode wires arranged away from each other in the hollow insulation body. The power supply members supply power to the two electrode wires. The sealing member is provided at an end of the sensor unit in a longitudinal direction. The power supply members are electrically connected to the electrode wires drawn out from one end of the hollow insulation body in the longitudinal direction, and include direction changing parts extending in a direction that intersects with the longitudinal direction of the sensor unit from electrode connection parts being parts connected to the electrode wires and further extending in a direction toward the other end side (inner side) in the longitudinal direction of the sensor unit. The sealing member seals the electrode connection parts, the direction changing parts, and the one end of the sensor unit in the longitudinal direction.

In the above-mentioned foreign matter detection sensor, a direction in which lead wires are drawn out from the sealing member (terminal part) is regulated to one direction along the longitudinal direction of the sensor unit. Accordingly, depending on an arrangement position of a draw-in port for drawing the lead wires in a vehicle body, the lead wires may be required to detour largely. In this case, a length of the lead wires is required to be increased, or a fixing structure of the lead wires is required to be set. Thus, cost increase, complication of a structure, and the like may be caused.

A need thus exists for a foreign matter detection sensor which is not susceptible to the drawback mentioned above.

### SUMMARY

In this disclosure, in order to achieve the above-mentioned main object, the following configurations are adopted.

A foreign matter detection sensor includes an outer coat, a plurality of electrode wires, and a terminal part. The outer coat has an insulation property and elasticity and is configured in an elongated hollow shape. The plurality of electrode wires are to be arranged away from each other in the outer coat. The terminal part is provided to an end of the outer coat in a longitudinal direction of the outer coat, and is configured to cover connection parts of lead wires respectively connected to the plurality of electrode wires, and draw the lead wires out from a bottom surface part to an outside. The foreign matter detection sensor is attached to an opening part of a vehicle body or to an opening and closing body configured to open and close the opening part, and is configured to detect nipping of a foreign matter between a peripheral edge of the opening part and the opening and closing body when the plurality of electrode wires are electrically connected due to a pressing force from the foreign matter. The terminal part includes, in a periphery of the bottom surface part, a plurality of guide parts for guiding arrangement directions of the lead wires drawn out from the bottom surface part to directions different from each other.

### BRIEF DESCRIPTION OF THE DRAWINGS

The foregoing and additional features and characteristics of this disclosure will become more apparent from the following detailed description considered with the reference to the accompanying drawings, wherein:

FIG. 1A and FIG. 1B are external views of a vehicle 1;

FIG. 2 is a sectional view taken along a line A-A in FIG. 1A;

FIG. 3 is a sectional view of a sensor unit 20 of a foreign matter detection sensor 10;

FIG. 4A and FIG. 4B are side views of a part of the sensor unit 20 and a terminal part 30, and FIG. 4C is a sectional view taken along a line B-B in FIG. 4A;

FIG. 5 is an explanatory view illustrating a state in which the foreign matter detection sensor 10 is mounted to a bracket 6;

FIG. 6 is an explanatory view illustrating a state in which the foreign matter detection sensor 10 is mounted to the bracket 6;

FIG. 7 is an explanatory view illustrating a state in which lead wires 40a and 40b are arranged inside in a longitudinal direction of a sensor;

FIG. 8 is an explanatory view illustrating a state in which the lead wires 40a and 40b are arranged on one side in a direction orthogonal to the longitudinal direction of the sensor;

FIG. 9 is an explanatory view illustrating a state in which the lead wires 40a and 40b are arranged on the other side in the direction orthogonal to the longitudinal direction of the sensor;

FIG. 10A and FIG. 10B are explanatory views illustrating a state in which the lead wires 40a and 40b are drawn in a vehicle body; and

FIG. 11 is a sectional view of a terminal part 130 in a modification example.

### DETAILED DESCRIPTION

An embodiment disclosed herein will be explained with reference to the attached drawings.

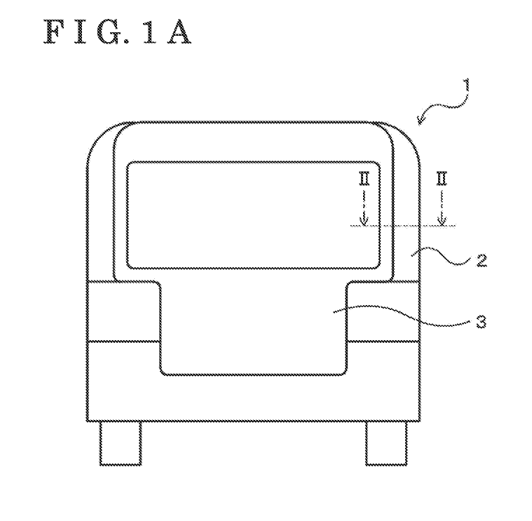

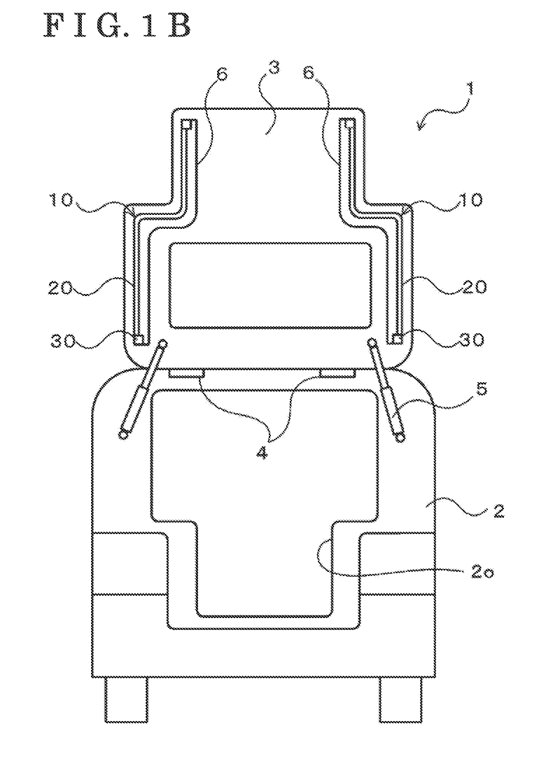

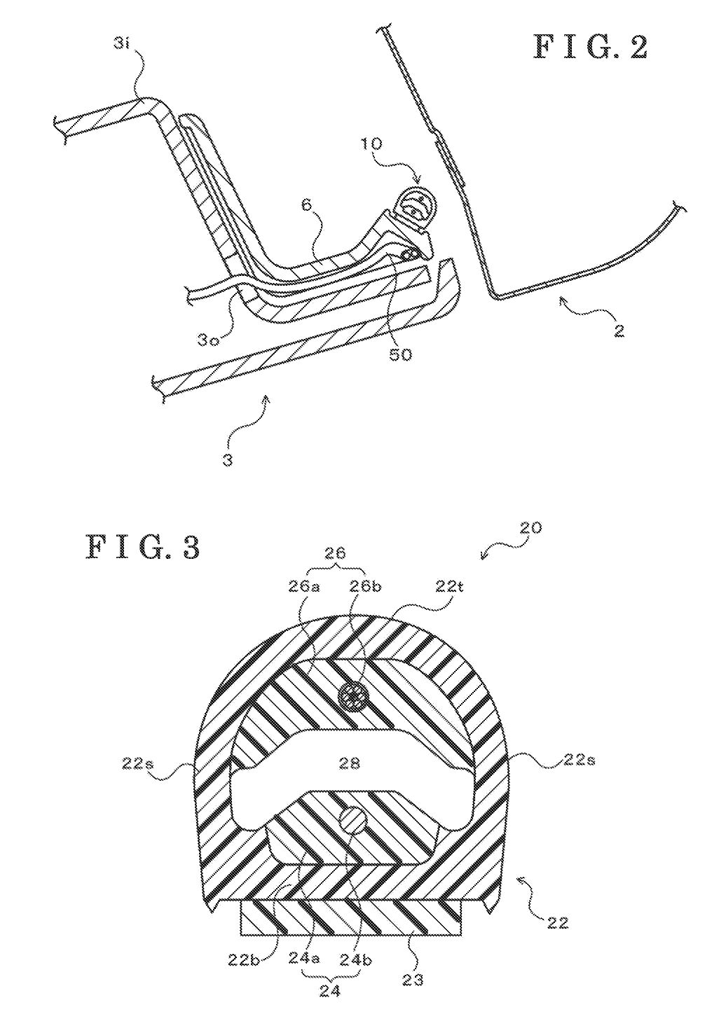

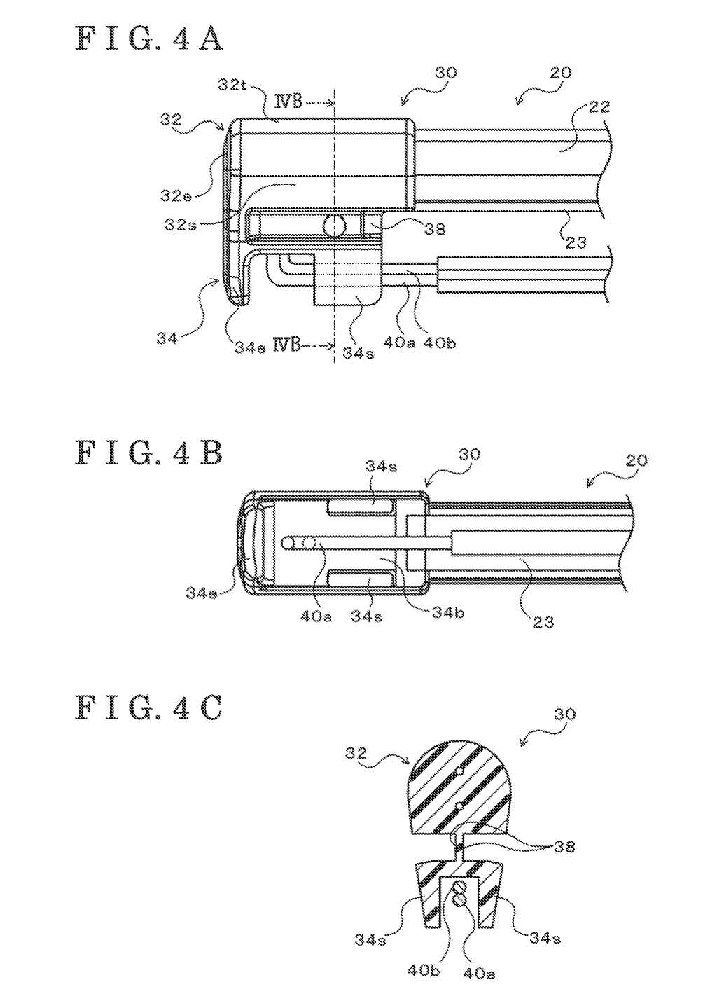

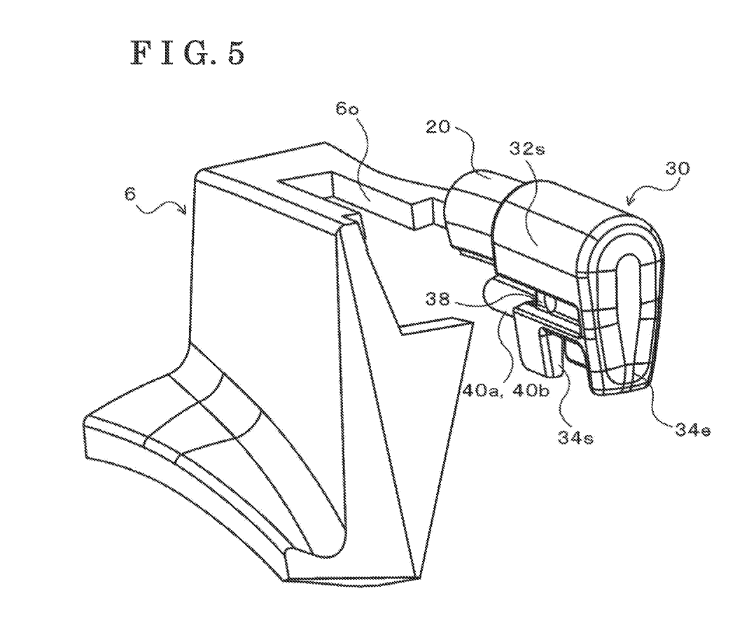

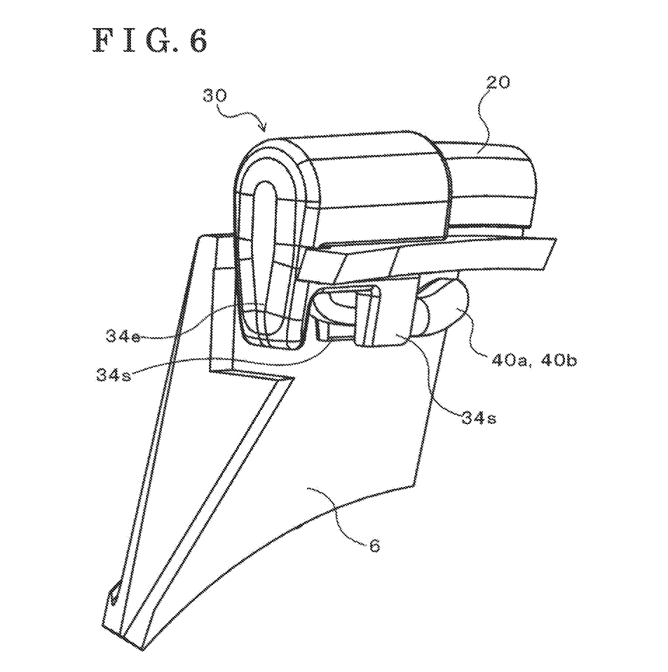

FIG. 1A and FIG. 1B are external views of a vehicle 1. FIG. 2 is a sectional view taken along a line A-A in FIG. 1A. FIG. 3 is a sectional view of a sensor unit 20 of a foreign matter detection sensor 10. FIG. 4A and FIG. 4B are side views of a part of the sensor unit 20 and a terminal part 30, and FIG. 4C is a sectional view taken along a line B-B in FIG. 4A. Further, FIG. 5 and FIG. 6 are explanatory views illustrating a state in which the foreign matter detection sensor 10 is mounted to a bracket 6. As illustrated in FIG. 1A and FIG. 1B, the vehicle 1 includes a vehicle body 2 including an opening part 2o in the rear, a door panel (back door panel) 3 mounted to the vehicle body 2 so as to cover the opening part 2o, and an electric door opening and closing device 5 interposed between the vehicle body 2 and the door panel 3 and configured to move the door panel 3 by driving of an actuator and perform opening and closing the opening part 2o. In the embodiment, an upper end of the door panel 3 is coupled to an upper end of the vehicle body 2 in the rear through intermediation of hinges 4, and the door panel 3 is configured as a lift type door having a lower end turning upward and downward about the hinges 4 as fulcrums.

As illustrated in FIG. 1B, at a peripheral edge of the door panel 3, the foreign matter detection sensor 10 configured to detect nipping of a foreign matter between the peripheral edge of the door panel 3 and a peripheral edge of the opening part 2o of the vehicle body 2 is provided.

The foreign matter detection sensor 10 includes the elastic and elongated sensor unit 20 and the terminal part 30 provided to an end of the sensor unit 20 in a longitudinal direction. As illustrated in FIG. 2, the foreign matter detection sensor 10 is fixed to each of both ends of an inner panel 3i (panel on a cabin side) of the door panel 3 in a right-and-left direction through intermediation of the bracket 6. The bracket 6 is an elongated member extending in an up-and-down direction at each of the both ends of the door panel 3 in the right-and-left direction. The sensor unit 20 includes a bottom surface that adheres to the bracket 6 by a double-sided tape under a state of being curved along an external form of the bracket 6. As illustrated in FIG. 5 and FIG. 6, a narrowed part 38 which is formed on a pair of side surface parts 32s and extends along the longitudinal direction of the sensor unit 20, is inserted in a recessed opening 6o formed in the bracket 6. In this manner, the terminal part 30 is engaged with the bracket 6.

As illustrated in FIG. 3, the sensor unit 20 includes an elastically deformable outer coat 22 formed of insulation elastomer in an elongated cylindrical shape, and a first electrode part 24 and a second electrode part 26, which are arranged in the outer coat 22 and extend in parallel to each other across a predetermined space 28 along a longitudinal direction of the outer coat 22.

The outer coat 22 is an elongated cylindrical body formed in a substantially D-shaped cross-sectional shape, and includes a bottom surface part 22b, a pair of side surface parts 22s, and a top surface part 22t. A double-sided tape 23 (adhesive surface) adhering to the bracket 6 is attached to an outer surface of the bottom surface part 22b. The pair of side surface parts 22s is provided upright on both sides of the bottom surface part 22b in a width direction. The top surface part 22t connects upper ends of the pair of side surface parts 22s to each other in an arc shape.

The first electrode part 24 includes a first conductive member 24a which has conductivity and elasticity and extends along the longitudinal direction of the outer coat 22, and a first core wire 24b which is embedded in the first conductive member 24a and extends along an extending direction of the first conductive member 24a. The first conductive member 24a is arranged on an inner surface side of the bottom surface part 22b of the outer coat 22. Note that, in the embodiment, the first core wire 24b is formed of, for example, copper as a single wire.

The second electrode part 26 includes a second conductive member 26a which has conductivity and elasticity and extends along the longitudinal direction of the outer coat 22, and a second core wire 26b which is embedded in the second conductive member 26a and extends in an extending direction of the second conductive member 26a. The second conductive member 26a is arranged on an inner surface side of the top surface part 22t of the outer coat 22. Note that the second core wire 26b is formed of a string-shaped core member having elasticity (flexibility) such as rubber, a plurality of lead wires spirally wound about the core member, and conductive fibers covering the core member and the lead wires, so as to have elasticity lower than that of the first core wire 24b. However, similarly to the first core wire 24b, the second core wire 26b may be formed as a single wire.

The sensor unit 20 (the outer coat 22, the first electrode part 24, and the second electrode part 26) are manufactured by extrusion molding. The extrusion molding is performed in the following manner. That is, the first core wire 24b and the second core wire 26b are guided to a cross head of an extrusion machine (not illustrated), and at the cross head, the first core wire 24b and the second core wire 26b are covered with the conductive elastomer (the first conductive member 24a and the second conductive member 26a, respectively) extruded on outer peripheries thereof. With this, the first electrode part 24 and the second electrode part 26 are formed. The first electrode part 24 and the second electrode part 26 are covered with the conductive elastomer extruded on the peripheries thereof to form the outer coat 22. Then, a molded product is picked up after passing through a cooling tank (not illustrated).

One end of the first core wire 24b and one end of the second core wire 26b are drawn out from one end of the outer coat 22, and are connected to two lead wires of a resistor (not illustrated), respectively. Then, the one end of the outer coat 22, two wire connection parts, and the resistor are covered with one terminal part formed by injection molding through use of a molding material such as insulating elastomer (for example, a styrene thermoplastic elastomer insulating material). The other ends of the first core wire 24b and the second core wire 26b are drawn out from the other end of the outer coat 22, and are connected to two lead wires 40a and 40b of a wire harness 40 to be connected to a control device (not illustrated), respectively. Further, the other end of the outer coat 22 and two wire connection parts are covered with another terminal part 30 formed by injection molding through use of similar molding material (see FIGS. 4A to 4C). The control device includes a DC power source configured to apply an electric current to the first core wire 24b and a resistance detection circuit configured to detect a resistance value between the first core wire 24b and the second core wire 26b. Usually, the first electrode part 24 (the first conductive member 24a) and the second electrode part 26 (the second conductive member 26a) are away from each other across the space 28, and the electric current applied to the first core wire 24b of the first electrode part 24 flows to the second core wire 26b of the second electrode part 26 through the resistor. Meanwhile, when the outer coat 22 is pressed down by a foreign matter, thereby bringing the first electrode part 24 (the first conductive member 24a) and the second electrode part 26 (the second conductive member 26a) into contact with each other, the first core wire 24b and the second core wire 26b are electrically short-circuited. Accordingly, the electric current applied to the first core wire 24b flows to the second core wire 26b without passing through the resistor. Therefore, the control device detects a change in resistance value between the first core wire 24b and the second core wire 26b, and accordingly, nipping of a foreign material can be detected.

The terminal part 30 includes a terminal part main body 32 for sealing the end of the outer coat 22 and the wire connection parts connecting the first core wire 24b and the second core wire 26b with the lead wires 40a and 40b, and a wall part 34 provided upright from a peripheral edge of a bottom surface part 32b of the terminal part main body 32. The lead wires 40a and 40b of the wire harness 40 connected to the first core wire 24b and the second core wire 26b, respectively, are bent in a substantially L shape, and are drawn out from the bottom surface part 32b of the terminal part main body 32. The wire harness 40, the lead wires 40a and 40b of which are drawn out from the bottom surface part 32b, is inserted through a draw-in port formed in the inner panel 3i, and is connected to the control device in the vehicle body.

The terminal part main body 32 includes the bottom surface part 32b, the pair of side surface parts 32s, a top surface part 32t, and an end surface part 32e, and is formed with an outer form slightly larger than the sensor unit 20. As described above, on the pair of side surface parts 32s of the terminal part main body 32, the narrowed part 38 to be inserted to the opening part 6o of the bracket 6 extends along the longitudinal direction of the sensor unit 20.

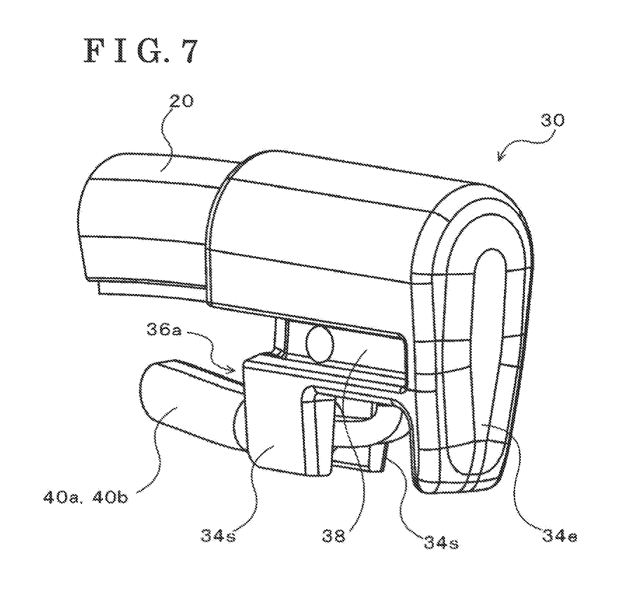

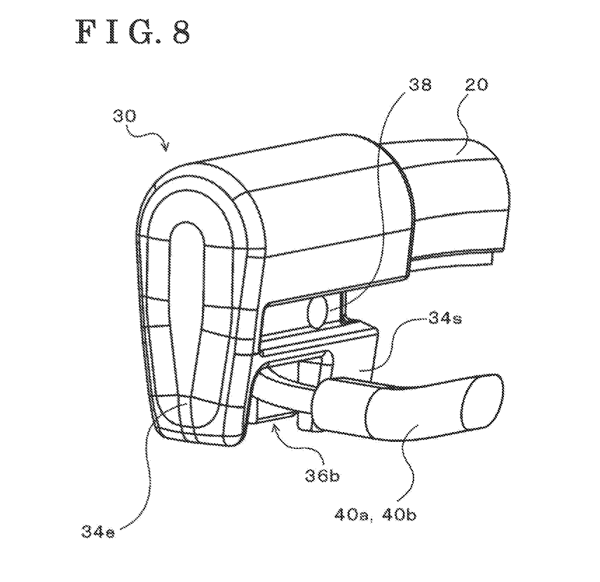

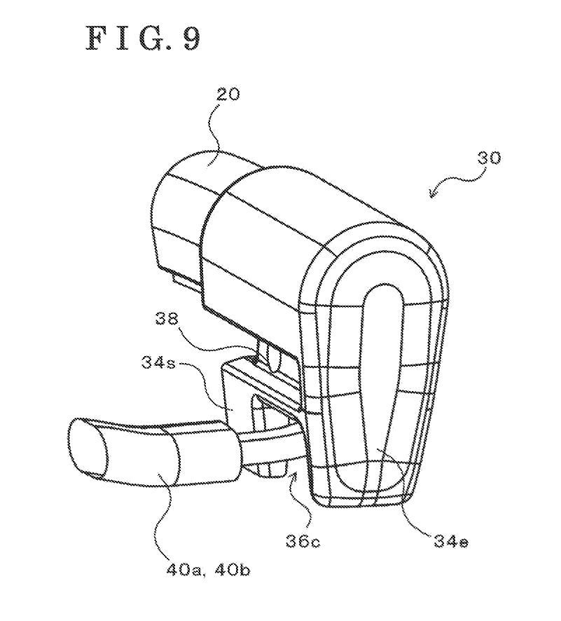

The wall part 34 includes an end wall part 34e provided upright so as to be continuous with the end surface part 32e of the terminal part main body 32, and a pair of side wall parts 34s provided upright away from the end wall part 34e with a gap so as to be continuous with the pair of side surface parts 32s of the terminal part main body 32. As illustrated in FIG. 4C, the pair of side wall parts 34s has a reversed U-shaped cross section connected to lower ends of the narrowed part 38. Recessed parts 36a, 36b, and 36c, each of which opens with a recessed shape, are formed between the pair of side wall parts 34s, between the end wall part 34e and one of the pair of side wall parts 34s, and between the end wall part 34e and the other of the pair of side wall parts 34s, respectively. As illustrated in FIG. 7, the recessed part 36a guides an arrangement direction of the lead wires 40a and 40b drawn out from the bottom surface part 32b of the terminal part main body 32 to be on an inner side of the sensor unit in a longitudinal direction. As illustrated in FIG. 8, the recessed part 36b guides an arrangement direction of the lead wires 40a and 40b drawn out from the bottom surface part 32b of the terminal part main body 32 to be on one side in a direction orthogonal to the sensor longitudinal direction. As illustrated in FIG. 9, the recessed part 36c guides an arrangement direction of the lead wires 40a and 40b drawn out from the bottom surface part 32b of the terminal part main body 32 to be on the other side in the direction orthogonal to the sensor longitudinal direction.

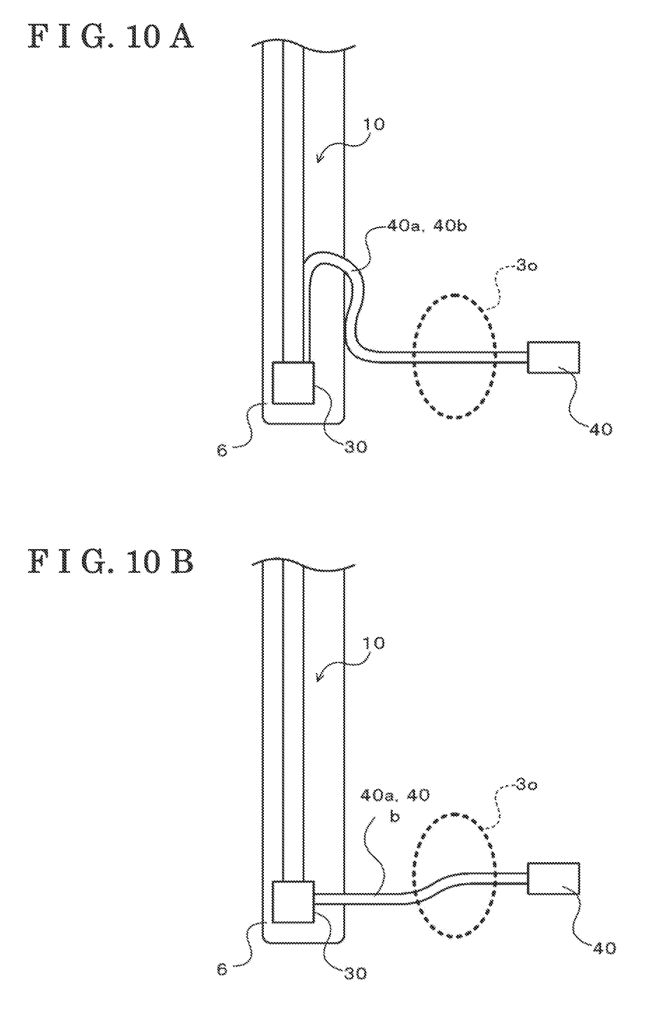

FIG. 10A and FIG. 10B are explanatory views illustrating a state in which the lead wires 40a and 40b are drawn in the vehicle body. Note that FIG. 10A illustrates a state in which the lead wires 40a and 40b are drawn through use of a terminal part 30B in a comparative example. FIG. 10B illustrates a state in which the lead wires 40a and 40b are drawn through use of the terminal part 30 in the embodiment. As illustrated, a draw-in port 3o for drawing the wire harness 40 (the lead wires 40a and 40b) in the vehicle body is formed so as to be substantially adjacent to the terminal part 30 in a direction orthogonal to the longitudinal direction of the sensor unit 20. In the terminal part 30B in the comparative example, an arrangement direction of the lead wires 40a and 40b is regulated to an inner side (the upper direction in FIG. 10A) of the sensor unit 20 in a longitudinal direction. Thus, in order to insert the lead wires 40a and 40b through the draw-in port 3o, the lead wires 40a and 40b are required to detour largely. Accordingly, the wire length is increased, and a fixing structure for the lead wires 40a and 40b is required in some cases. In contrast, in the terminal part 30 in the embodiment, the arrangement direction of the lead wires 40a and 40b can be set to both sides in the direction orthogonal to the longitudinal direction in addition to the inner side of the sensor unit 20 in the longitudinal direction. Thus, the lead wires 40a and 40b can be inserted through the draw-in port 3o and easily drawn in the vehicle body without detouring largely. Therefore, in the terminal part 30 in the embodiment, the wire length of the lead wires 40a and 40b can be reduced, and a fixing structure for the lead wires 40a and 40b is not required.

Bent parts of the lead wires 40a and 40b, which are drawn out from the bottom surface part 32b of the terminal part main body 32, in the arrangement direction, are hidden. Thus, the end wall part 34e may have a satisfactory appearance.

Moreover, as illustrated in FIG. 4C, the pair of side wall parts 34s is formed in a tapered shape so as to be close to each other as outer surface sides thereof approach distal ends (lower sides in FIG. 4C). With this structure, when the terminal part 30 is engaged with the bracket 6, the narrowed part 38 can be fitted to the opening part 6o by pressing the pair of side surface parts 32s into the opening part 6o of the bracket 6. Accordingly, mountability can be improved.

The foreign matter detection sensor 10 according to the above-mentioned embodiment includes the terminal part 30 provided to the end of the outer coat 22 in the longitudinal direction, and configured to cover the connection parts of the lead wires 40a and 40b, which are connected to the first electrode part 24 and the second electrode part 26 (the first core wire 24b and the second core wire 26b), respectively, and draws the lead wires 40a and 40b out from the bottom surface part 32b to the outside. In the periphery of the bottom surface part 32b, the terminal part 30 includes the plurality of recessed parts 36a to 36c (guide parts) for guiding arrangement directions of the lead wires 40a and 40b drawn out from the bottom surface part 32b to directions different from each other. The lead wires 40a and 40b are arranged from a recessed part among the plurality of recessed parts 36a to 36c of the terminal part 30, a direction of the recessed part being closest to the draw-in port 3o for drawing the lead wires 40a and 40b in the vehicle body. In this manner, the lead wires 40a and 40b can be drawn in the vehicle body without detouring. The lead wires 40a and 40b have a degree of freedom in arrangement paths as described above. Thus, also in a case where the foreign matter detection sensor 10 is applied to a plurality of kinds of vehicle bodies, the lead wires 40a and 40b drawn out from the terminal part 30 can easily be drawn in the vehicle body. As a result, the wire length of the lead wires 40a and 40b is not required to be increased, and a fixing structure for the lead wires 40a and 40b is not required, and hence cost can be reduced.

In the above-mentioned embodiment, the arrangement directions of the lead wires 40a and 40b drawn out from the bottom surface part 32b of the terminal part 30 can be set to the inner side of the sensor unit 20 in the longitudinal direction and both sides in the direction orthogonal to the longitudinal direction, that is, to three in total. However, this disclosure is not limited thereto. One of the three may be omitted. Alternatively, for example, a recessed part may be also provided to the end wall part 34e, and then the arrangement direction of the lead wires 40a and 40b may be provided on an outer side of the sensor unit 20 in the longitudinal direction. The arrangement directions of the lead wires 40a and 40b are only required to be set to a plurality of directions different from each other.

In the above-mentioned embodiment, the outer surfaces of the pair of side wall parts 34s of the terminal part 30 are formed in a tapered shape. However, the outer surfaces of the pair of side wall parts 34s may be parallel to each other.

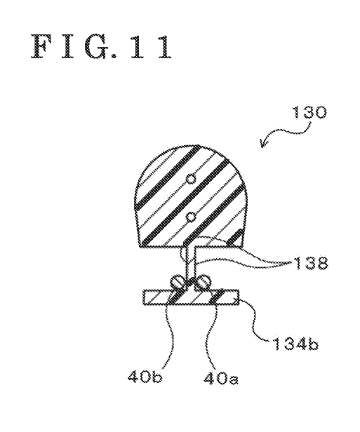

In the above-mentioned embodiment, the pair of side wall parts 34s of the terminal part main body 32 is formed in a reversed U-shaped cross section. However, as the terminal part 130 in the modification example illustrated in FIG. 11, in place of the pair of side wall parts 34s, a bottom wall part 134b connected to a lower end of narrowed part 138 may be included so as to have a reversed T-shaped cross section. In this case, when the lead wires 40a and 40b are drawn out on the inner side of the sensor in the longitudinal direction, the narrowed part 138 has a width larger than that of the narrowed part 38 in the embodiment. Accordingly, the lead wires 40a and 40b can be arranged on both sides of the narrowed part 138.

In the above-mentioned embodiment, the foreign matter detection sensor 10 is provided to the back door device for opening and closing the opening part 2o, which is provided to the rear of the vehicle body 2, with the door panel (back door panel) 3. However, this disclosure is not limited thereto. For example, the foreign matter detection sensor may be provided to a slide door device for opening and closing an opening part (entrance door) provided to a side of the vehicle body 2 by sliding a slide door panel frontward and rearward, or the foreign matter detection sensor may be provided to a power window device for opening and closing an opening part (window) provided to a side of the vehicle body 2 by lifting and lowering a window glass. Thus, the foreign matter detection sensor according to this disclosure is applicable to any opening and closing device as long as the opening and closing device opens and closes an opening part by moving an opening and closing body by driving of an actuator.

Description is made of correspondence between the main elements of the embodiment and the main elements of this disclosure described in SUMMARY. In the embodiment, the outer coat 22 corresponds to “outer coat,” the first electrode part 24 (the first conductive member 24a and the first core wire 24b) corresponds to “first electrode wire,” the second electrode part 26 (the second conductive member 26a and the second core wire 26b) corresponds to “second electrode wire,” the lead wires 40a and 40b correspond to “lead wires,” the opening part 2o corresponds to “opening part,” the door panel 3 corresponds to “opening and closing body,” and the recessed parts 36a to 36c correspond to “guide parts.” Further, the end wall part 34e corresponds to “end wall part.” Further, the bracket 6 corresponds to “fixing member.” The narrowed part 38 corresponds to “narrowed part,” and the side wall parts 34s correspond to “side wall parts.”

Note that the correspondence between the main elements of the embodiment and the main elements of this disclosure described in SUMMARY is merely an example for specifically describing the embodiment for carrying out this disclosure described in SUMMARY. Thus, the elements of this disclosure described in SUMMARY are not limited thereto. That is, this disclosure described in SUMMARY is to be interpreted based on the description of SUMMARY, and the embodiment is merely a specific example for carrying out this disclosure described in SUMMARY.

Description has been made of the embodiment for carrying out this disclosure. However, this disclosure is not limited to the embodiment at all, and can be achieved with various modes without departing from the gist of this disclosure.

This disclosure is applicable to a manufacturing industry of a foreign matter detection sensor, and the like.

A foreign matter detection sensor includes an outer coat, a plurality of electrode wires, and a terminal part. The outer coat has an insulation property and elasticity and is configured in an elongated hollow shape. The plurality of electrode wires are to be arranged away from each other in the outer coat. The terminal part is provided to an end of the outer coat in a longitudinal direction of the outer coat, and is configured to cover connection parts of lead wires respectively connected to the plurality of electrode wires, and draw the lead wires out from a bottom surface part to an outside. The foreign matter detection sensor is attached to an opening part of a vehicle body or to an opening and closing body configured to open and close the opening part, and is configured to detect nipping of a foreign matter between a peripheral edge of the opening part and the opening and closing body when the plurality of electrode wires are electrically connected due to a pressing force from the foreign matter. The terminal part includes, in a periphery of the bottom surface part, a plurality of guide parts for guiding arrangement directions of the lead wires drawn out from the bottom surface part to directions different from each other.

The foreign matter detection sensor according to this disclosure includes the terminal part provided to one end of the outer coat in a longitudinal direction of the outer coat, and configured to cover connection parts of the lead wires connected to the plurality of electrode wires, and draw the lead wires out from the bottom surface part to an outside. The terminal part includes, in a periphery of the bottom surface part, a plurality of guide parts for guiding arrangement directions of the lead wires drawn out from the bottom surface part to directions different from each other. When the foreign matter detection sensor is applied to a plurality of kinds of vehicle bodies, the lead wires are arranged by use of a guide part among the plurality of guide parts of the terminal part, a direction of the guide part being closest to a draw-in port for drawing the lead wires in the vehicle body. In this manner, the lead wires can be drawn in the vehicle body without detouring. The lead wires have a degree of freedom in arrangement paths as described above. Thus, also in the case where the foreign matter detection sensor is applied to a plurality of kinds of vehicle bodies, the lead wires drawn out from the terminal part can easily be drawn in the vehicle body. As a result, the wire length of the lead wires is not required to be increased, and a fixing structure for the lead wires is not required, and hence cost can be reduced.

In the foreign matter detection sensor according to this disclosure, the plurality of guide parts may be configured to guide arrangement directions of the lead wires to an inner side in the sensor longitudinal direction and both sides in a direction orthogonal to the sensor longitudinal direction.

With this structure, the arrangement directions of the lead wires can be guided to the three directions, and the lead wires can have a high degree of freedom in arrangement paths.

Further, in the foreign matter detection sensor according to this disclosure, the terminal part may include an end wall part provided upright from an edge on an outer side of the bottom surface part in the sensor longitudinal direction.

With this structure, bent parts of the lead wires drawn out from the terminal part do not appear externally. Thus, a satisfactory appearance can be achieved.

Moreover, in the foreign matter detection sensor according to this disclosure, the terminal part may include, on a side surface part, a narrowed part extending in the sensor longitudinal direction and to be inserted in an opening part of a fixing member, and on the bottom surface part, two side wall parts provided upright in the same direction from both edges in a direction orthogonal to the sensor longitudinal direction, and outer surfaces of the two side wall parts may be formed in a tapered shape so as to be close to each other as the outer surfaces approach distal ends.

With this structure, the terminal part can be fixed to the fixing member by pressing the terminal part into the opening part of the fixing member from the side wall part sides. Accordingly, workability can be improved.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A foreign matter detection sensor, comprising:
an outer coat having an insulation property and elasticity and configured in an elongated hollow shape;
a plurality of electrode wires to be arranged away from each other in the outer coat; and
a terminal part provided to an end of the outer coat in a longitudinal direction of the outer coat, and configured to cover connection parts of lead wires connected to the plurality of electrode wires, and draw the lead wires out from a bottom surface part to an outside,
the foreign matter detection sensor being attached to an opening part of a vehicle body or to an opening and closing body configured to open and close the opening part, and being configured to detect nipping of a foreign matter between a peripheral edge of the opening part and the opening and closing body when the plurality of electrode wires are electrically connected due to a pressing force from the foreign matter,
the terminal part including, in a periphery of the bottom surface part, a plurality of guide parts for guiding arrangement directions of lead wires drawn out from the bottom surface part to directions different from each other.

2. The foreign matter detection sensor according to claim 1, wherein
the plurality of guide parts are configured to guide arrangement directions of the lead wires to an inner side in a sensor longitudinal direction and both sides in a direction orthogonal to the sensor longitudinal direction.

3. The foreign matter detection sensor according to claim 1, wherein
the terminal part includes an end wall part provided upright from an edge on an outer side of the bottom surface part in a sensor longitudinal direction.

4. The foreign matter detection sensor according to claim 2, wherein
the terminal part includes an end wall part provided upright from an edge on an outer side of the bottom surface part in the sensor longitudinal direction.

5. The foreign matter detection sensor according to claim 1, wherein
the terminal part includes, on a side surface part, a narrowed part extending in a sensor longitudinal direction and to be inserted in an opening part of a fixing member, and on the bottom surface part, two side wall parts provided upright in a same direction from both edges in a direction orthogonal to the sensor longitudinal direction, and
outer surfaces of the two side wall parts are formed in a tapered shape to be close to each other as the outer surfaces approach distal ends.

6. The foreign matter detection sensor according to claim 2, wherein
the terminal part includes, on a side surface part, a narrowed part extending in a sensor longitudinal direction and to be inserted in an opening part of a fixing member, and on the bottom surface part, two side wall parts provided upright in a same direction from both edges in a direction orthogonal to the sensor longitudinal direction, and
outer surfaces of the two side wall parts are formed in a tapered shape to be close to each other as the outer surfaces approach distal ends.

7. The foreign matter detection sensor according to claim 3, wherein
the terminal part includes, on a side surface part, a narrowed part extending in a sensor longitudinal direction and to be inserted in an opening part of a fixing member, and on the bottom surface part, two side wall parts provided upright in a same direction from both edges in a direction orthogonal to the sensor longitudinal direction, and
outer surfaces of the two side wall parts are formed in a tapered shape to be close to each other as the outer surfaces approach distal ends.
